(19) United States
(12) Patent Application Publication
(10) Pub. No.: US 2024/0322117 A1
(43) Pub. Date: Sep. 26, 2024

(54) FREEZE CASTING OF ELECTRODES

(71) Applicant: FORD MOTOR COMPANY, Dearborn, MI (US)

(72) Inventors: Benjamin Jason Emley, Canton, MI (US); Paul John Bojanowski, Macomb Township, MI (US)

(21) Appl. No.: 18/184,960

(22) Filed: Mar. 16, 2023

(51) Int. Cl. H01M 4/04; H01M 4/505; H01M 4/525; H01M 4/62

(52) U.S. Cl. CPC H01M 4/0471; H01M 4/0416; H01M 4/505; H01M 4/525; H01M 4/622; H01M 4/625

(57) ABSTRACT

Methods and systems to prepare electrodes such as for electrochemical cells (e.g., batteries). In various embodiments, a complex mixture of at least two polymer-solvent solutions undergoes a unique temperature treatment to prepare an electrode. The mixture includes at least a first solution including a first solvent and a second solution including a second solvent that is different from the first solvent. A first polymer is dissolved in the first solvent but insoluble in the second solvent and a second polymer is dissolved in the second solvent but insoluble in the first solvent. In one or more embodiments, a continuous drying process that combines variable frequency microwaves, a vacuum, and a temperature treatment is disclosed.

### TECHNICAL FIELD

Methods and systems to produce unique films such as electrode films for electrochemical cells such as batteries are disclosed.

### BACKGROUND

Efforts to use and develop alternative sources of energy other than fossil fuels are underway. Many of these efforts require reliable and efficient storage of the energy harnessed from these alternative sources. Modern electrochemical cells include a plurality of electrodes which are important to their operation and efficiency are frequently used.

### SUMMARY

A method of forming a battery electrode is disclosed. The method includes adding an electrode active material and a support material for depositing the electrode active material thereon to a solution to form an electrode slurry, applying the slurry to a cooled substrate, and then heating the slurry. The solution includes a first solvent with a first polymer dissolved therein and a second solvent with a second polymer dissolved therein. The first polymer being soluble in the first solvent and the second polymer being soluble in the second solvent. In a refinement, the first polymer is insoluble in the second solvent and the second polymer is insoluble in the first solvent. The cooled substrate is cooled to a temperature below the freezing point of the second solvent such that it freezes and the second polymer precipitates. These conditions may induce evaporation of the first solvent, or the slurry may be heated to induce evaporation of the first solvent to precipitate the first polymer. The remaining slurry may be heated to melt the second solvent and evaporate it. The temperature may be raised to remove of the first polymer such as by thermal decomposition. During this process the electrode active material is deposited on the electrode support which is dispersed in the polymer matrix that remains. The polymer matrix having a freeze casting structure.

A composition to prepare electrodes is also disclosed. A first solution of a first polymer dissolved in a first solvent and a second solution of a second polymer dissolved in a second solvent. In a refinement, the first polymer may be insoluble in the second solvent and the second polymer may be insoluble in the first solvent. The first solvent having a higher vaporization pressure than the second solvent and the second solvent having a greater freezing point than the first solvent.

A drying system for preparing electrodes is also disclosed. The drying system includes a drying chamber to receive an article having a coating thereon, a microwave source in communication with the drying chamber, and a negative pressure source in communication with the drying chamber. The microwave source being arranged to provide variable frequency microwaves to the coating while in the drying chamber. The combination of the variable frequency microwaves and source of negative pressure cooperating to dry the coating to form a film on the substrate.

### BRIEF DESCRIPTION OF THE DRAWINGS

FIG. 1 is a flow chart of a method of making porous film such as for an electrode.

FIG. 2 is a schematic of an electrode slurry being applied to a substrate.

FIG. 3 is a schematic of an embodiment of an electrode layer.

FIG. 4 is a perspective view of the electrode layer.

FIG. 5 is a cross-sectional schematic of a drying system.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Moreover, except where otherwise expressly indicated, all numerical quantities in this disclosure are to be understood as modified by the word “about” in describing the broader scope of this disclosure. Practice within the numerical limits stated is generally preferred. Also, unless expressly stated to the contrary: percent, “parts of,” and ratio values are by weight. The term “polymer” includes “oligomer,” “copolymer,” “terpolymer,” and the like. The description of a group or class of materials as suitable or preferred for given purpose implies the mixtures of any two or more of the members of the group or class are equally suitable or preferred. Molecular weights provided for any polymers refers to number average molecular weight. A description of constituents in chemical terms refers to the constituents at the time of addition to any combination specified in the description and does not necessarily preclude chemical interactions among the constituents of a mixture once mixed.

The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property. This disclosure is not limited to the specific embodiments and methods described below, as specific components and/or conditions may vary. Furthermore, the terminology used herein is used only for the purpose of describing particular embodiments and is not intended to be limiting in any way.

The term “substantially” or “generally” may be used herein to describe disclosed or claimed embodiments. The term “substantially” or “generally” may modify a value or relative characteristic disclosed or claimed in the present disclosure. In such instances, “substantially” or “generally” may signify that the value or relative characteristic it modifies is within +0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1, to 2.1 the following numbers 1.2, 1.3, 1.4, 1.5, 1.6, 1.7, 1.8, 1.9, and 2.0 can be selected as lower or upper limits.

As described herein soluble refers to a solubility of at least 1.0 gram of solute per liter of solvent (g/L), or more preferably at least 2.5 g/L, or even more preferably at least 5 g/L and insoluble refers to a solubility of less than 1.0 g/L, or more preferably less than 0.5 g/L, or even more preferably less than 0.1 g/L at 25° C.

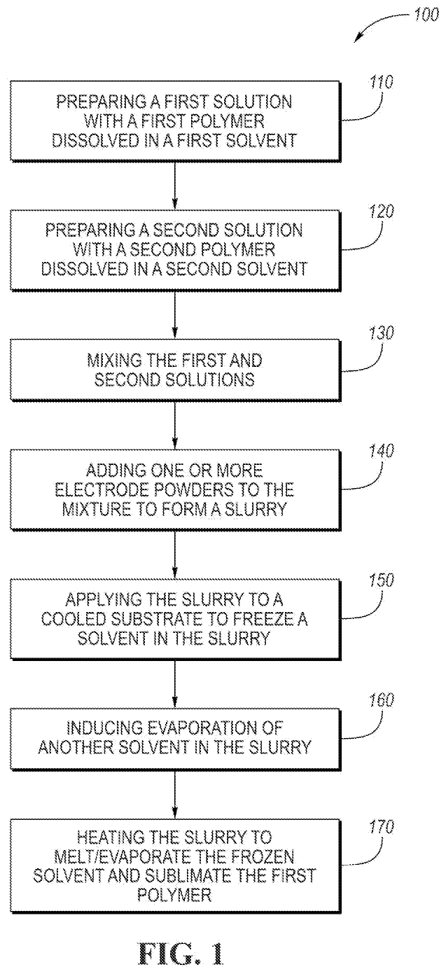

Referring to FIG. 1, a method 100 to prepare a film such as an electrode layer for an electrochemical cell (e.g., battery) is disclosed. The method 100 includes preparing a plurality of solutions such as a first and second solution (i.e., steps 110 and 120), mixing the plurality of solutions (i.e., step 130) together to form a mixture, adding powder to the mixture to form a slurry (i.e., 140), applying the slurry to a substrate (i.e., 150), and freeze casting/drying the slurry to form a film having a structure with an isotropic order such as aligned pores on the substrate (i.e., steps 150-170).

In one or more embodiments, the first solution includes a first solvent and a first polymer, and the second solution includes a second solvent and a second polymer. For example, the first polymer may be dissolved in the first solvent and the second polymer may be dissolved in the second solvent. In various embodiments, the first polymer is soluble in the first solvent but insoluble in the second solvent and the second polymer is soluble in the second solvent but insoluble in the first solvent. The first and second solutions/solvents are miscible with each other such that they can be mixed to form a mixture such that the polymers do not precipitate out merely by mixing to the two solution together.

In a variation, the first solvent has a high vapor pressure (e.g., higher vapor pressure than a second solvent of the second solution). In one or more embodiments, the first solvent may have a vapor pressure of at least 10 kPa, or more preferably at least 20 kPa, or even more preferably at least 30 kPa at 25° C. In a refinement, the vapor pressure of the first solvent is at least 10 kPa greater than the vapor pressure of the second solvent, or more preferably at least 15 kPa greater, or even more preferably at least 25 kPa greater. In a refinement, the first solvent may have a low boiling point (e.g., lower boiling point than the second solvent). In one or more embodiments, the boiling point of the first solvent may be less than 80° C. at 1 atm, or more preferably of less than 70° C., or even more preferably less than 60° C. In a variation, the boiling point of the first solvent is at least 10° C. less than the boiling point of the second solvent, or more preferably at least 15° C. less, or even more preferably at least 20° C. less than the boiling point of the second solvent. In a refinement, the first solvent may be a polar solvent and the first polymer may be a polyolefin such as a polypropylene. For example, the first solvent may be acetone or methyl ethyl ketone (MEK) and the first polymer may be a polypropylene carbonate. Formula (I) below represents a polymer structure that may be suitable:

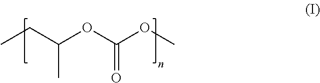

In a variation, the second solvent has a greater freezing point than the first solvent. For example, the freezing point may be at least −25° C., or more preferably at least 0° C., or even more preferably at least 15° C., or still even more preferably at least 25° C. In a refinement, that second solvent has a freezing point that is at least 25° C. greater than the first solvent, or more preferably at least 50° C. greater, or even more preferably at least 100° C. greater. In various embodiments, the second polymer has a greater decomposition temperature than the first polymer. For example, the decomposition temperature of the second polymer may be at least 25° C. greater than the decomposition temperature of the first polymer, or more preferably at least 50° C. greater than the decomposition temperature of the first polymer, or even more preferably at least 100° C. greater than the decomposition temperature of the first polymer. In a variation, the decomposition temperature may be determined according to gravimetric analysis such as ASTM E1131-08 with a heating rate of 10° C./minute and the decomposition temperature may be the point at which a 1% weight loss occurs, or more preferably at which a 5% weight loss occurs, or even more preferably at which a 10% weight loss occurs, or still more preferably at which 50% weight loss occurs, or yet more preferably at which 90% weight loss occurs.

In a refinement, the second solvent is polar solvent such as an alcohol (e.g., tert-butyl alcohol) and the second polymer is a rubber or polyolefin (e.g., polyvinyl) such as polybutadiene rubber, (e.g., a hydrolyzed nitrile butadiene rubber (HNBR)), polyvinyl butyral, polyvinyl pyrrolidone, or a combination thereof. Formula (II) below represents a polymer structure that may be suitable:

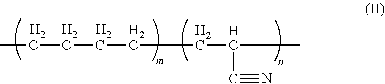

In a variation, the first and second solutions may be mixed together at a volume ratio of 1:5 to 5:1, or more preferably 1:3 to 3:1, or even more preferably 1:2 to 2:1, or still more preferably 1:1. In one or more embodiments, the solutions and mixtures may be provided at ratios to increase stability and/or provide specific characteristics such as a stable viscosity. For example, the first polymer may be added at additional or excessive quantities to increase the viscosity, for example, to 500 cps, or more preferably 1,000 cps, or even more preferably 5,000 cps because the first polymer may be removed through heating.

Powders such as ceramics and other electrode materials may be added to the mixture to form a slurry (e.g., a dispersion). In one or more embodiments, the powders may be mixed under high shear such as with a high shear mixer to achieve a sufficient dispersion. In a refinement, surfactants such as dispersants may be added to assist or achieve a sufficient dispersion. In a variation, an electrode active material (which may include precursors thereof) and/or deposit/support material for the electrode active material may be added such that during film formation the electrode active material is deposited on the deposit/support material. For example, a cathode active material such as lithium cobalt oxides (LiCoO₂), lithium nickel manganese cobalt oxides (Li-NMC), lithium nickel cobalt aluminum oxides e.g., Li(NiCoAl)O₂, lithium manganese oxides (LiMn₂O), and/or lithium iron phosphates (LiFePO₄) may be used. Alternatively, an anode active material such as graphite may be used. An electrode support may also be used in combination with the electrode active material. For example, the electrode active material may be deposited on the electrode support. In a variation, carbon black powder may be used as an electrode support material. Other additives may be added to the slurry such as conductive additives. Preferably the slurry is made from materials that do not negatively and/or significantly affect the solubility of the solutions. For example, the solubility remains the same or is only minimally reduced such as by no more than 10%, or more preferably by no more than 3%, or even more preferably by no more than 1%.

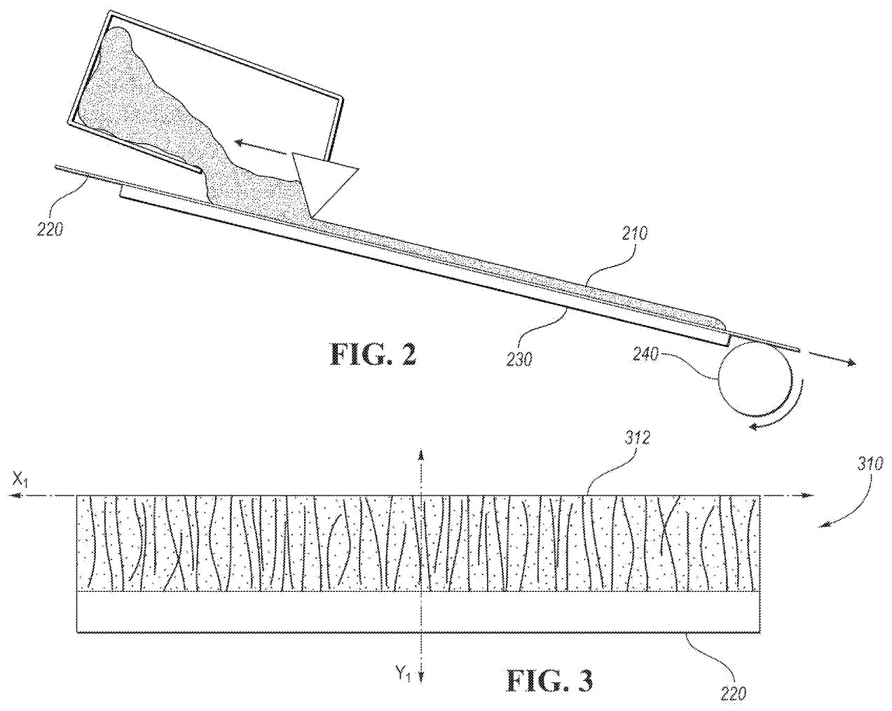

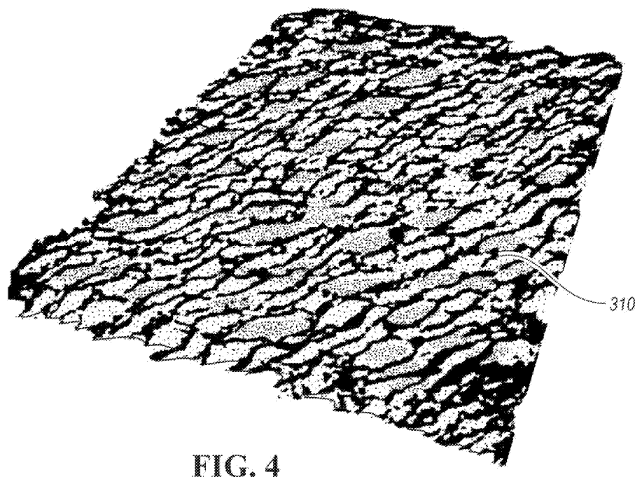

Referring to FIG. 2, the slurry 210 may be applied to a substrate 220 such as a metal substrate, foil, or tape. The application method is not particularly limited and may include casting, roll-to-roll, slot die, doctor blade, spraying (e.g., aerosol or ultrasonic), additive manufacturing (3D printing), slip casting, spin coating, or any other suitable application technique. In various embodiments, the slurry 210 is applied at a thickness that creates a thermal gradient when the substrate 220 is cooled such that the coolest area would be adjacent the substrate and the warmest area would be furthest from the substrate. For example, the substrate 220 may be cooled by a temperature control system 230 such as Peltier system. In a refinement, the process may be continuous. For example, the slurry 210 may be applied to a continuous substrate 220 (e.g., a tape/foil) that translate by way of one or more rollers 240 such that the continuous substrate 220 with slurry 210 thereon (having a substantial uniform thickness) is disposed along and adjacent a temperature control system such as a cooling/heating plate. In some embodiments, a thermal gradient may contribute to a unique freeze casting structure such that the slurry 210 is freeze casted into a porous coating/film 310 with vertically aligned pores. In one or more embodiments, the substrate is cooled to a first threshold temperature at or below the freezing point of the second solvent (e.g., tert-butyl alcohol). For example, the first threshold temperature may be less than 25° C., or more preferably less than 0° C., or even more preferably less than −20° C. In a refinement, the substrate is cooled to a temperature at or below the freezing point prior to the slurry 210 being applied. Thus, when the slurry 210 is applied, the second solvent freezes (e.g., tert-butyl alcohol) increasing the viscosity of the slurry. In a refinement, the second polymer (e.g., HNBR), which is insoluble in the first solvent, precipitates out of the mixture as a result of the second solvent being frozen to form a polymer matrix 312 having a unique vertical structure or column-like structure (i.e., an isotropic order such as from vertically aligned pores) where the columns extend away from the substrate towards the free surface, as shown in FIG. 3. In a refinement, the unique structure is a result of the polymer nucleating away in the path of the temperature gradient. In various embodiments, without being bound by theory, it is believed that the freezing of the second solvent (e.g., tert-butyl alcohol) decreases the mobility or immobilizes the first polymer (e.g., polypropylene carbonate) although still dissolved in the first solvent (e.g., acetone or MEK).

In one or more embodiments, the first solvent (e.g., acetone or MEK) is removed after the second solvent is frozen and without melting the second solvent. For example, the first solvent (e.g., acetone or MEK) having a relatively higher vapor pressure than the second solvent may evaporate. In various embodiments, the freezing of the second solvent may induce or promote evaporation of the first solvent (e.g., acetone or MEK). In other embodiments, the slurry may be heated to a second threshold temperature that is less than the freezing point but more than the first threshold temperature to induce or promote evaporation. For example, the second threshold temperature may be from −15 to 25° C., or more preferably from 0 to 25° C., or even more preferably from 15 to 25° C. Alternatively, first solvent is removed without heating. The removal of the first solvent is not particularly limited with the exception that the second solvent remains frozen. As the first solvent (e.g., acetone or MEK) is removed such as by evaporation the first polymer (e.g., polypropylene carbonate) precipitates out of the mixture or remains behind with a similar isotropic order such as having vertically aligned pores. As the liquid solvent amount is reduced the electrode active material (e.g., Li-NMC) is deposited on the electrode support material (e.g., carbon black) and dispersed in the polymer matrix 312 that remains. The temperature may again be raised to a third threshold temperature to melt and evaporates the second solvent. In a refinement, removal of the second solvent such as by sublimination is preferably so that it does not re-dissolve the second polymer. For example, the third threshold temperature is less than the triple point of the second solvent (e.g., tert-butyl alcohol). The third threshold temperature may be 0 to 20° C., or more preferably 5 to 19° C., or even more preferably 15 to 18° C. Simultaneously, or more preferably after the second solvent is evaporated, the remaining structure may be heated to a fourth threshold temperature to remove the first polymer (e.g., polypropylene carbonate). Removal of the first polymer provides superior interconnectivity of electronic and ionic pathways by producing a porous polymer matrix with vertically aligned pores along the vertically extending polymer columns, as shown in FIG. 4. For example, the fourth threshold temperature may be more than a decomposition temperature of the first polymer (e.g., polypropylene carbonate) but less than the decomposition temperature of the second polymer (e.g., HNBR). For example, the fourth threshold temperature may be 200 to 400° C., or more preferably 250 to 350° C., or even more preferably 280 to 325° C.

In various embodiments, the drying or the removal of the solvents may be achieved without a vacuum while still achieving a freeze casting structure formed by a polymer matrix with the electrode active material deposited on the electrode support which is dispersed therein. This process may, for example, be used with roll to roll processes as a vacuum is not necessary. In a refinement, the freeze casting structure has an anisotropic order. For example, the pores of the structure may be aligned such that an average dimension along a first axis/direction is greater than along a second axis/direction. Referring to FIG. 3, the casted/dried (electrode) film 310 has a structure including a plurality of pores that are aligned along an axis Y₁ that is generally perpendicular to an axis X₁ along the face of the film/coating 310 such that the average pore dimension along the Y₁ axis/direction is greater than the average pore dimension along the X₁ axis/direction. In a refinement, the average dimension along the first axis/direction may be at least 1.5 times the average dimension along the second axis/direct, or more preferably at least twice as large, or even more preferably at least three times as large. For example, the average dimension along the first axis/direction may be 30-60 μm and the dimension along the second axis/direction may be 10-20 μm. In various embodiments, the full distribution of pore dimensions may have similar properties, e.g., the pores' dimensions along a first axis/direction may be up to 120 μm and the pores' dimensions along a second axis/direction may be up to 40 μm. Although the structure may have aligned pores, the pore size is not particularly limited to, for example, the ranges provided herein, and various parameters may be adjusted to alter the pore size to a suitable size for a particular use. The sizes herein are examples to illustrate pore alignment and preferred dimensional ratios. In one or more embodiment, the resulting film may have a porosity of 3 to 40%, or more preferably 5 to 25%, or even more preferably 7.5 to 12.5% as determined, for example, by ASTM C1039-85.

In a variation, one or more additional polymers may be added to increase performance. For example, a third polymer may be added to increase performance such as viscosity and/or mechanical properties of the final polymer matrix 312 of the coating/film 310 on the substrate 220. For example, the third polymer may increase strength of an electrode layer. In various embodiments, the third polymer is soluble in at least the first or second solvent such that it can be added to one of the solutions. Alternatively, the one or more additional polymers may include homogenizer, which increases miscibility of the first and second polymers and/or first and second solutions, i.e., the third polymer may be soluble in both the first and second solvent. For example, polyethylene glycol, ethyl cellulose, and/or polyvinyl pyrrolidone may be used as homogenizer. The one or more additional polymers may have a plasticizing effect on the final film such that mechanical properties are altered such as by reducing hardness but increasing viscoelastic properties such as elasticity and durability. In a refinement, the one or more additional polymers (e.g., third polymer) may have a decomposition temperature that is greater than the first polymer such that it remains in the final film to alter performance properties. If the one or more additional polymers are used solely as a homogenizer the one or more additional polymers may have a decomposition temperature that is less than the second and/or first polymer. The one or more additional polymers may, for example, increase adhesion to the substrate (e.g., metal foil), increase cohesive strength such as between electrode support particles.

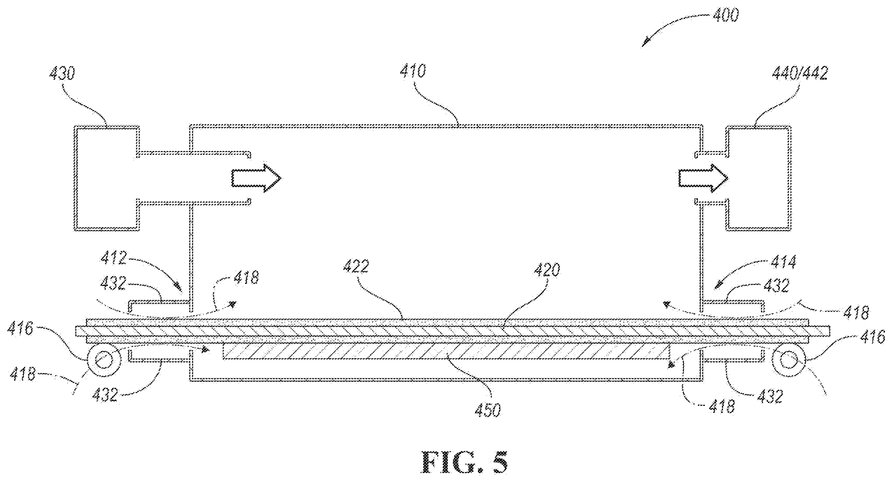

Referring to FIG. 5, a drying system 400 to prepare electrodes is disclosed. The drying system 400 includes a drying chamber 410 to receive an article 420 having a wet coating 422 thereon, a microwave source 430 in communication with the drying chamber 410, and a negative pressure source 440 such as a vacuum in communication with the drying chamber 410. In a refinement, the drying chamber 410 has an inlet 412 to receive the article 420 and an outlet 414 to remove the article 420. In a variation, the inlet 412 and outlet 414 are arranged such that a continuous system such as a conveyor system 416 (e.g., tape or belt system) moves an articles having a wet coating, or a plurality/series of articles having wet coatings thereon through the drying chamber 410 for drying. In a refinement, the inlet 412 and outlet 414 are open or large enough that they do not negatively affect, cause defects, or otherwise reduce the quality of the coating 422. In other words, there may be a gap between wet coating 422 and the walls delimiting the inlet 412 and outlet 414. The dried coating may have a porous morphology with generally aligned pores as the solvent is immobilized by freezing and then quickly removed such as by sublimation with little or no change in structure.

In various embodiments, the article 420 is not particularly limited but may be a metal (e.g., steel or aluminum) sheet/ribbon. In a refinement, the wet coating 422 may be applied to both sides (i.e., opposite side of the generally planar sheet/ribbon) or a plurality of sides of the article 420. In a variation, the wet coating 422 is a polymeric and/or ceramic coating such as an electrode coating. In some embodiments, the wet coating 422 may be water-based. In one or more embodiments, the microwave source is arranged to provide variable frequency microwaves to the coating. For example, a sequences of different frequency microwaves may be provided to the coating to facilitate evaporation and control solvent extraction rates. In various embodiments, one or more microwave chokes 432 may be disposed at the inlet 412 and outlet 414 to stop or mitigate microwave radiation from exiting the drying chamber 410.

In one or more embodiments, the negative pressure source 440 is a vacuum (i.e., a device capable of providing a pressure less than atmospheric pressure e.g., 1 atm). In a variation, the negative pressure source 440 is sufficient to produce an atmosphere where the primary liquid medium of the wet coating 422 such as the primary solvent is sublimed. In a refinement, the negative pressure source 440 is sufficient to provide a pressure below the triple point of primary medium of the wet coating 422 such as the primary solvent. For example, in a refinement, the coating 422 may be water-based and the primary solvent is water, in which case, the negative pressure source 440 is sufficient to provide a pressure of no more than 610 Pa, or more preferably no more than 605 Pa, or even more preferably no more than 600 Pa. In various embodiment, the negative pressure source 440 also accommodates for gaps present at the inlet 412 and outlet 414 which allow for continuous processing instead of batch processing.

In one or more embodiments, the drying system 400 also includes a solvent trap 442 to remove the solvent evaporated or extracted from the coating 422. In a variation, the solvent trap 442 is disposed within a gaseous exit path/passage of the negative pressure source 440. In a refinement, the solvent trap is cooled to a temperature at or below the crystallization temperature of the solvent. For example, if the solvent is xylene the solvent trap 442 may be cooled to at no more than −47° C., or more preferably no more than −43° C., or even more preferably no more than −35° C. Thus, when the xylene evaporates from the coating 422 and is drawn from the drying chamber 410 by the negative pressure source 440 (e.g., vacuum) as a gas it passes through the solvent trap 442 and crystallizes such that it is removed from the gaseous flow and collected by the solvent trap 442.

In various embodiment, the combination and coordination of the microwave source 430 and the negative pressure source 440 precisely controls evaporation and the solvent extraction rate such that the structure and quality of the coating can be controlled. In a variation, a controller (not shown) having a non-transitory computer readable medium with computer executable instruction stored thereon. The instructions may be executable by a processor to control and coordinate the microwave source 430 and negative pressure source 440.

In various embodiments, the drying system 400 includes a cooling plate 450 disposed in the drying chamber 410 and adjacent the coating 422 and/or article 420. The cooling plate 450 may be used for freeze drying and/or freeze casting. For example, the cooling plate may freeze the solvent of the wet coating 422 that is then excited by the microwave radiation and sublimes due to the low-pressure atmosphere brought about by the negative pressure source 440. In a refinement, the cooling plate 450 may be a Peltier cooling system. The cooling plate 450 may be cooled to a temperature that is less than the crystallization temperature of the solvent. In a variation, the cooling plate 450 is at a temperature less than or equal to the crystallization temperature but more than the solvent trap 442 such that the sublimation occurs in the drying chamber 410 but not the solvent trap 442. For example, in one or more embodiments, when water is the solvent, the cooling plate may be less than 0.01° C. In other words, the cooling plate cools the coating to between −5 and 0.01° C., or more preferably between −10 and 0.01° C., or even more preferably between −15 and 0.01° C. and the solvent trap may be no more than −5° C., or more preferably no more than −10° C., or even more preferably no more than −15° C.

The system 400 may also include a temperature control unit (not shown) to heat a working gas 418 such as a gas that is drawn in from the gaps of the inlet 412 and/or outlet 414 (shown as arrows). The temperature control unit may further control the atmospheric temperature within the partially vacuumed drying chamber 410 to control evaporation/extraction rate more precisely.

Further unlike, other conventional processes such as roll-to-roll where the coating is applied and dried along the entire ribbon, even where the ribbon will be cut, the instant drying system allows for precision such that energy does not need to be wasted on drying portion that will be cut or deformed or disposed. For example, microwave radiation may not be emitted or targeted at area where the ribbon will be cut or deformed.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method to form battery electrodes comprising:
adding an electrode active material and an electrode support material to a mixture to form an electrode slurry, the mixture including a first solvent, a second solvent, a first polymer dissolved in the first solvent and a second polymer dissolved in the second solvent;
applying the slurry to a cooling substrate, the cooling substrate being cooled to a temperature below a freezing point of the second solvent to freeze the second solvent and precipitate the second polymer;
inducing evaporation of the first solvent to precipitate the first polymer; and
heating such that the second solvent evaporates and the first polymer is removed and that the electrode active material is deposited on the electrode support and dispersed in a polymeric matrix having a freeze casting structure.

2. The method of claim 1, wherein the first polymer is insoluble in the second solvent and the second polymer is insoluble in the first solvent.

3. The method of claim 1, wherein the freeze casting structure is achieved without a vacuum.

4. The method of claim 1, wherein the slurry is applied at a thickness such that a temperature gradient in the slurry is formed by the cooled substrate.

5. The method of claim 1, wherein a third polymer is added to the mixture to increases mechanical strength.

6. The method of claim 5, wherein the first and second solutions are mixed at a volume ratio of 1:2 to 2:1.

7. A composition to prepare electrodes comprising:
a mixture including a first solution comprising a first polymer dissolved in a first solvent, and a second solution comprising a second polymer dissolved in a second solvent, wherein the first solvent has a higher vaporization pressure than the second solvent, and the second solvent has a greater freezing point than the first solvent.

8. The composition of claim 7, wherein the first polymer is insoluble in the second solvent and the second polymer is insoluble in the first solvent.

9. The composition of claim 7, wherein the first solvent is acetone or methyl ethyl ketone.

10. The composition of claim 8, wherein the second solvent is tert-butyl alcohol.

11. The composition of claim 9, wherein the first polymer is a polypropylene.

12. The composition of claim 10, wherein the second polymer includes hydrolyzed nitrile butadiene rubber, polyvinyl butyral, polyvinyl pyrrolidone, or a combination thereof.

13. The composition of claim 7, wherein the mixture further includes an electrode active material and an electrode support.

14. The composition of claim 13, wherein the electrode active material is Li-NMC and the electrode support is carbon black.

15. A drying system for preparing electrodes comprising:
a drying chamber to receive an article having a coating thereon;
a microwave source in communication with the drying chamber and arranged to provide variable frequency microwaves to the coating; and
a negative pressure source in communication with the drying chamber such that when the article is received, the microwave source and the negative pressure source cooperate to dry the coating to form a film on the article.

16. The system of claim 15, further comprising a cooling plate adjacent the substrate or coating to freeze cast the coating.

17. The system of claim 15, further comprising a conveyor system to continuous transport a plurality of articles each having a coating thereon through the drying chamber.

18. The system of claim 17, further comprising a temperature control unit to condition a working gas received through a gap around the conveyor system.

19. The system of claim 15, wherein the coating is a ceramic electrode coating.

20. The system of claim 15, further comprising a solvent trap in communication with the chamber.
